(19) United States
(12) Patent Application Publication
(10) Pub. No.: US 2011/0195256 A1
(43) Pub. Date: Aug. 11, 2011

(54) Photocurable Primer Composition And Coated Structure Comprising Cured Primer Composition

(76) Inventors: Ikutaro Morikawa, kanagawa (JP); Motoshi Sasaki, Chiba (JP)

(21) Appl. No.: 13/060,798

(22) PCT Filed: Aug. 25, 2009
(86) PCT No.: PCT/JP2009/065145

§ 371 Date: Apr. 27, 2011

(30) Foreign Application Priority Data
Aug. 28, 2008 (JP) JP2008-219459

(51) Int. Cl. B32B 27/08; C08F 2/46; B32B 27/00; B32B 27/28

(52) U.S. Cl. 428/412; 522/99; 428/447; 427/515

(57) ABSTRACT

To provide a photocurable primer composition that cures to form a primer layer that exhibits an excellent adhesion to substrate, a structure having this primer layer and a method of producing such a structure. A photocurable primer composition comprising (a) multifunctional acrylates, (b) organoalkoxysilane having an aliphatically unsaturated bond, (c) photopolymerization initiator, and (d) organic solvent. Also, a structure comprising a primer layer comprising the aforementioned photocurable primer composition, formed on the substrate, and a cured coating comprising (e) ultraviolet absorber and (c) photopolymerization initiator, formed on the primer layer.

### TECHNICAL FIELD

The present invention relates to a photocurable primer composition. More specifically, the present invention relates to a photocurable primer composition that can be readily cured by ultraviolet radiation and that cures to form a primer layer that exhibits an excellent adhesion to substrate and in particular imparts an excellent adhesion to substrate to cured coatings obtained by photocuring. The present invention further relates to a structure having this primer layer and to a production method of such a structure.

### BACKGROUND ART

Ultraviolet-curing coating agents are well suited in particular for coating the surface of substrates that comprise low-heat-resistance thermoplastic resin and for protecting the substrates and thus offer the advantages of being able to impart excellent physical characteristics (e.g., resistance to staining and contamination, resistance to scratching and marring, smoothness, and so forth) and of being able to do this without significantly impairing the physical strength of these substrates.

Photo-curable coating agents of this type are known. For example, an abrasion-resistant, ultraviolet-curable coating composition is known that comprises a non-silyl acrylate, colloidal silica, acryloxy-functional silane, and photopolymerization initiator (Patent Reference 1). Also known is a high energy radiation-curable composition that characteristically comprises alkoxy-functional organopolysiloxane and multifunctional acrylate (Patent Reference 2). A high energy radiation-curable acryloxysilicone composition that exhibits an improved physical strength is also known; this composition comprises multifunctional acrylate, colloidal silica, organoalkoxysilane, and amino-modified organopolysiloxane or its Michael addition reaction product (Patent Reference 3). In addition, these references teach that known photopolymerization initiators can be suitably used when these same compositions are to be cured by ultraviolet radiation.

The pretreatment of a substrate surface (e.g., various substrates such as polycarbonate and so forth) with a primer in order to improve the adhesion between a photocuring-type coating agent and the substrate is also known. Thus, there is known a method of curing a photocuring-type coating agent, comprising the steps of coating with a primer, then applying the photocuring-type coating agent to the primer-coated substrate, and then exposing the photocuring-type coating agent to light in order to cure the photocuring-type coating agent (refer, for example, to Patent Reference 1, Patent Reference 4, and Patent Reference 5).

However, substrates comprising a thermoplastic resin, e.g., polycarbonate resin, are readily photodegraded by ultraviolet radiation with a wavelength around 300 nm, and when such substrates have been used in an environment in which long-term exposure to sunlight occurs, e.g., outdoors and so forth, the timewise deterioration of the coated substrate itself has been a problem. Another problem has been the deterioration in the substrate itself due to the unavoidable necessity of exposing the substrate to ultraviolet radiation during the cure of the photocuring-type coating agent.

The incorporation of an ultraviolet absorber is known for the purpose of stopping the aforementioned ultraviolet-induced deterioration of thermoplastic resin substrates and improving the weathering resistance (for example, paragraph number 0019 in Patent Reference 3). However, this ultraviolet absorber also absorbs the ultraviolet radiation required to cure the coating agent, and, when incorporated in large amounts in the coating agent in order to improve the weathering resistance, it inhibits the ultraviolet-mediated cure of the coating agent. This has resulted in the problem of an impaired adhesion between the substrate and a cured coating formed by the cure of a coating agent that comprises an ultraviolet absorber and a photopolymerization initiator.

It is further known that a photostabilizer can also be incorporated in a photocuring-type coating agent as an additive (for example, Patent Reference 6). By scavenging the radical species generated by exposure to the ultraviolet radiation in sunlight, the incorporation of a photostabilizer can improve the ultraviolet protective effect and weathering resistance of the cured coating in environments in which long-term exposure to sunlight occurs, for example, outdoors and so forth. However, hindered amine-type photostabilizers also scavenge the radical species produced during the ultraviolet radiation-induced curing of the coating agent, and as a consequence the incorporation of a hindered amine-type photostabilizer in large amounts results in a cancellation of the effects of the ultraviolet radiation and an inhibition of coating agent cure. This has resulted in the problem of an impaired adhesion between substrate and a cured coating from a coating agent that contains an ultraviolet absorber and a photopolymerization initiator.
[Patent Reference 1] JP 57-500984 A
[Patent Reference 2] JP 2002-012638 A
[Patent Reference 3] JP 2004-269589 A
[Patent Reference 4] JP 59-204669 A
[Patent Reference 5] JP 11-001005 A
[Patent Reference 6] JP 62-001402 B

### SUMMARY OF INVENTION

### Technical Problems to be Solved

The present invention seeks to solve the problems identified above and provides a photocurable primer composition that can be readily cured by ultraviolet radiation and that cures to form a primer layer that exhibits an excellent adhesion to substrate and in particular imparts an excellent adhesion to substrate to cured coatings obtained by photocuring. The present invention also provides a structure in which a substrate is tightly adhered via this primer layer in particular to a photocuring-type cured coating that comprises an ultraviolet absorber or a hindered amine-type photostabilizer. The present invention further provides a production method of this structure.

### Solution to Problems

As a result of intensive investigations directed to solving the problems identified as above, the present inventors discovered that these problems could be solved by a photocurable primer composition comprising (a) a multifunctional acrylate or multifunctional methacrylate, (b) an organoalkoxysilane having an aliphatically unsaturated bond, (c) a photopolymerization initiator, and (d) an organic solvent. The present invention was achieved based on this discovery.

The present inventors also discovered that the problems identified above could be solved by a structure comprising (L1) a substrate, (L2) a primer layer comprising the photocurable primer composition of claim 1, formed on the substrate, and (L3) a cured coating comprising (e) ultraviolet absorber and (c) photopolymerization initiator and optionally (f) a hindered amine-type photostabilizer, formed on the primer layer. The present invention was achieved based on this discovery.

The present inventors further discovered that the problems identified as above could be best solved by a production method of the structure, characteristically comprising a step of coating the above-described photocurable primer composition on a substrate comprising polycarbonate resin; a step of photocuring the photocurable primer composition to form a primer layer; a step of coating, on the primer layer, a photocuring-type coating agent comprising (c) photopolymerization initiator and (e) ultraviolet absorber and optionally (f) a hindered amine-type photostabilizer; and a step of photocuring the photocuring-type coating agent to form a cured coating. The present invention was achieved based on this discovery.

The aforementioned objects are achieved by

“[1] A photocurable primer composition comprising (a) a multifunctional acrylate or multifunctional methacrylate, (b) an organoalkoxysilane having an aliphatically unsaturated bond, (c) a photopolymerization initiator, and (d) an organic solvent.
[2] A structure comprising (L1) a substrate, (L2) a primer layer comprising the photocurable primer composition of [1], formed on the substrate, and (L3) a cured coating comprising (e) ultraviolet absorber and (c) photopolymerization initiator, formed on the primer layer.
[3] The structure according to [2], characterized in that the cured coating is a cured coating that further comprises (f) hindered amine-type photostabilizer.
[4] The structure according to [2], characterized in that the substrate is a transparent substrate that has a light transmittance of at least 70% in the visible region and in that the aforementioned structure is substantially transparent.
[5] A production method of the structure described in any of [2] to [4], characteristically comprising (S1) a step of coating the photocurable primer composition of claim 1 on a substrate; (S2) a step of photocuring the photocurable primer composition to form a primer layer; (S3) a step of coating, on the aforementioned primer layer, a photocuring-type coating agent comprising (e) ultraviolet absorber and (c) photopolymerization initiator; and (S4) a step of photocuring the photocuring-type coating agent to form a cured coating comprising the (e) ultraviolet absorber and (c) photopolymerization initiator.
[6] The production method of the structure according to [5], characterized in that the substrate is polycarbonate resin and the cured coating is a cured coating comprising (c) photopolymerization initiator, (e) ultraviolet absorber, and (f) hindered amine-type photostabilizer.”

### Advantageous Effects of Invention

The present invention can provide a photocurable primer composition that can be readily cured by ultraviolet radiation and that cures to form a primer layer that exhibits an excellent adhesion to substrate and in particular imparts an excellent adhesion to substrate to cured coatings obtained by photocuring. The present invention can also provide a structure in which a substrate is tightly adhered via this primer layer to a photocuring-type cured coating comprising an ultraviolet absorber or a hindered amine-type photostabilizer. The present invention can also provide a method of producing this structure.

In particular, the use of the aforementioned primer composition substantially improves the adhesion between a substrate and a photocuring-type coating agent-based cured coating for which a goal is an improved ultraviolet-absorbing performance. As a consequence, the combined use of this primer layer with a cured coating that comprises, for example, an ultraviolet absorber, is particularly well suited for improving the weathering resistance and surface protection of polycarbonate resin products, which are easily photodegraded and deteriorated by ultraviolet radiation around the 300 nm wavelength, and can provide structures that are useful as members (e.g., automotive external trim, external building features, and so forth) for use in environments in which long-term exposure to sunlight occurs, e.g., outdoors and so forth.

### DESCRIPTION OF EMBODIMENTS

The photocurable primer composition regarding the present invention will be considered first. This photocurable primer composition characteristically comprises (a) a multifunctional acrylate or multifunctional methacrylate, (b) an organoalkoxysilane that has an aliphatically unsaturated bond, (c) a photopolymerization initiator, and (d) an organic solvent.

More specifically, the photocurable primer composition of the present invention preferably comprises the individual components at the following ratio of incorporation.
(a) 100 weight parts of the multifunctional acrylate or multifunctional methacrylate
(b) 1 to 200 weight parts of the organoalkoxysilane that has an aliphatically unsaturated bond
(c) 0.01 to 30 weight parts of the photopolymerization initiator
(d) 10 to 2,000 weight parts of the organic solvent

Components (a) to (d) are described in detail in the following.

Component (a) is a multifunctional acrylate or multifunctional methacrylate. Component (a) functions to provide the photocurable primer composition with photocurability under exposure to ultraviolet radiation and, through its combined use with component (b), vide infra, functions to provide a primer layer that exhibits an excellent affinity for photocuring-type cured coatings that contain an ultraviolet absorber or hindered amine-type photostabilizer.

Component (a) is preferably a multifunctional acrylate and may or may not contain the fluorine atom and/or silicon atom; however, it preferably contains neither the fluorine atom nor silicon atom. This multifunctional acrylate is an at least difunctional (for example, difunctional to eicosafunctional) acrylate monomer or an at least difunctional (for example, difunctional to eicosafunctional) acrylate oligomer. Viewed from the perspective of the curability, the use is preferred of at least pentafunctional (for example, pentafunctional to decafunctional) acrylate. This multifunctional acrylate can be specifically exemplified by difunctional acrylate monomers such as 1,6-hexanediol diacrylate, 1,4-butanediol diacrylate, ethylene glycol diacrylate, diethylene glycol diacrylate, tetraethylene glycol diacrylate, tripropylene glycol diacrylate, neopentyl glycol diacrylate, 1,4-butanediol dimethacrylate, poly(butanediol) diacrylate, tetraethylene glycol dimethacrylate, 1,3-butylene glycol diacrylate, triethylene glycol diacrylate, triisopropylene glycol diacrylate, polyethylene glycol diacrylate, bisphenol A dimethacrylate, and so forth; trifunctional acrylate monomers such as trimethylolpropane triacrylate, trimethylolpropane trimethacrylate, pentaerythritol monohydroxy triacrylate, trimethylolpropane triethoxytriacrylate, and so forth; tetrafunctional acrylate monomers such as pentaerythritol tetraacrylate, ditrimethylolpropane tetraacrylate, and so forth; pentafunctional and higher functional acrylate monomers, such as dipentaerythritol hexaacrylate, dipentaerythritol (monohydroxy) pentaacrylate, and so forth; and acrylate oligomers such as bisphenol A epoxy diacrylate, hexafunctional aromatic urethane acrylate (trademark: Ebecryl 220), aliphatic urethane diacrylate (trademark: Ebecryl 230), and tetrafunctional polyester acrylate (trademark: Ebecryl 80). A single one of these multifunctional acrylates may be used or two or more may be used in combination. Among the preceding, the presence of pentafunctional and/or higher functional acrylate is preferred; its content is preferably at least 30 weight % (for example, 30 weight % to 100 weight %) of component (a) and more preferably is at least 50 weight % and even more preferably at least 80 weight %.

Component (b) is an organoalkoxysilane that has at least one aliphatically unsaturated bond in the molecular. This component contributes curability to the photocurable primer composition of the present invention in that it crosslinks with component (a) under exposure to ultraviolet radiation and thereby increases the degree of crosslinking in the primer layer. The combined use of this component (b) with component (a) functions to improve the post-cure affinity of the primer layer for photocuring-type cured coatings that contain an ultraviolet absorber or hindered amine-type photostabilizer and to thereby provide a strong adhesion between the substrate and cured coating via the interposed primer layer.

Component (b) may or may not contain the fluorine atom, but in general does not contain the fluorine atom. This component (b) is preferably a compound with the general formula R¹ₐYSi(OR²)₃₋ₐ. R¹ in this formula is substituted or unsubstituted monovalent hydrocarbyl (for example, C₁₋₂₀) that does not contain an aliphatically unsaturated bond and can be exemplified by alkyl such as methyl, ethyl, propyl, butyl, isobutyl, octyl, decyl, and so forth; aryl such as phenyl; and fluoroalkyl such as 3,3,3-trifluoromethyl, perfluorobutylethyl, perfluorooctylethyl, and so forth. Preferred thereamong are methyl, ethyl, propyl, butyl, and isobutyl. R² is alkyl and preferably C₁₋₁₀ alkyl and particularly preferably is methyl, ethyl, or propyl. Y is a monovalent organic group (for example, C₁₋₁₀) that contains an aliphatically unsaturated bond and can be exemplified by acrylic group-containing organic groups such as methacryloxy, acryloxy, 3-(methacryloxy)propyl, 3-(acryloxy)propyl, and so forth; alkenyl groups such as vinyl, hexenyl, allyl, and so forth; as well as by the styryl group and vinyl ether group. a is 0 or 1.

Component (b) can be specifically exemplified by 3-methacryloxytrimethoxysilane, 3-(methacryloxy)propyltrimethoxysilane, 3-(methacryloxy)propyltriethoxysilane, 3-(methacryloxy)propylmethyldimethoxysilane, 3-(acryloxy)propyltrimethoxysilane, vinyltrimethoxysilane, vinyltriethoxysilane, methylvinyldimethoxysilane, and allyltriethoxysilane. The component (b) content in the composition of the present invention is 1 to 200 weight parts per 100 weight parts of component (a) and preferably is 10 to 100 weight parts per 100 weight parts of component (a) and particularly preferably is 25 to 75 weight parts per 100 weight parts of component (a). The affinity for photocuring-type cured coatings comprising an ultraviolet absorber or hindered amine-type photostabilizer becomes inadequate when the component (b) content is less than the cited lower limit, which can result in debonding of the cured coating formed on the primer layer.

Component (c) is a photopolymerization initiator; this component brings about the photocuring of components (a) and (b) by generating radicals when exposed to high energy light, for example, ultraviolet radiation. There are no particular limitations on the photopolymerization initiator used by the present invention, and a single known photopolymerization initiator may be used or two or more known photopolymerization initiators may be used in combination.

The photopolymerization initiator is also not particularly limited as to type and can be exemplified, inter alia, by aryl ketone photopolymerization initiators (e.g., acetophenones, benzophenones, alkylaminobenzophenones, benzils, benzoins, benzoin ethers, benzil dimethyl ketals, benzoyl benzoates, α-acyloxime esters, and so forth), sulfur-containing photopolymerization initiators (e.g., sulfides, thioxanthones, and so forth); and acylphosphine oxide-type photopolymerization initiators. The photopolymerization initiator can also be used in combination with a photosensitizer, for example, an amine.

More specifically, component (c) is preferably a photopolymerization initiator selected from 2,4,6-trimethylbenzoyldiphenylphosphine oxide, 2-methyl-1-[4-(methylthio)phenyl]-2-morpholinopropan-1-one, 1-hydroxycyclohexyl phenyl ketone, 2-benzyl-2-dimethylamino-1-(4-morpholinophenyl)butanon-1-one, bis-2,6-dimethoxybenzoyl-2,4,4-trimethylpentylphosphine oxide, benzophenone, thioxanthone, 2-chlorothioxanthone, 2,4-diethylthioxanthone, isopropylthioxanthone, and 1-chloro-4-propoxythioxanthone. A single one of these may be used or two or more may be used in combination.

Particularly suitable examples of component (c) are 2,4,6-trimethylbenzoyldiphenylphosphine oxide, 2-methyl-1-[4-(methylthio)phenyl]-2-morpholinopropan-1-one, and 1-hydroxycyclohexyl phenyl ketone. These photopolymerization initiators are commercially available and the “Irgacure 907” and “Irgacure 184” (Irgacure is a registered trademark) products provided by Ciba Specialty Chemicals are suitably used.

The component (c) content in the photocurable primer composition of the present invention is 0.01 to 30 weight parts per 100 weight parts of component (a), while 5 to 20 weight parts is preferred from the point of view of the curing properties and adhesion by the primer layer to the substrate. The composition has an inadequate ultraviolet curability at below the cited lower limit. When the cited upper limit is exceeded, even though this is component (c), the physical strength of the resulting primer layer is reduced, which can cause the primer layer and cured coating to separate from the substrate.

An organic solvent (d), and particularly an alcohol-containing organic solvent, is used in the photocurable primer composition of the present invention as a dispersion medium for components (a) to (c). The component (d) content is preferably in the range of 10 to 2000 weight parts per 100 weight parts of component (a) and more preferably is in the range of 500 to 2000 weight parts per 100 weight parts component (a).

Specific examples of the alcohols encompassed by component (d) are alcohols such as methanol, ethanol, isopropyl alcohol, butanol, isobutyl alcohol, ethylene glycol, diethylene glycol, triethylene glycol, ethylene glycol monomethyl ether, diethylene glycol monomethyl ether, triethylene glycol monomethyl ether, propylene glycol monomethyl ether, and polyethylene glycol monomethyl ether (PGME). Non-alcohol organic solvents can be exemplified by ketones (e.g., C₂₋₂₀) such as acetone, methyl ethyl ketone, methyl isobutyl ketone, and so forth; aromatic hydrocarbons (e.g., C₂₋₂₀) such as toluene, xylene, and so forth; aliphatic hydrocarbons (e.g., C₅₋₂₀) such as hexane, octane, heptane, and so forth; organochlorine-type solvents (e.g., C₁₋₂₀) such as chloroform, methylene chloride, trichloroethylene, carbon tetrachloride, and so forth; and esters (e.g., C₁₋₂₀) such as ethyl acetate, butyl acetate, isobutyl acetate, and so forth. The alcohol content is preferably in the range of 10 to 99 weight % of the total quantity of the solvent and more preferably is 30 to 95 weight %.

Water may also be incorporated as a component (e) in the photocurable primer composition of the present invention. This component (e) is an optional component that is used to promote the hydrolysis of component (b). Its content is preferably in the range of 1 to 50 weight parts per 100 weight parts of component (b) and more preferably is in the range of 5 to 30 weight parts.

The composition of the present invention may incorporate, in a range in which the objects of the present invention are not impaired, components other than the preceding. Examples are tetraalkoxysilanes such as tetramethoxysilane, tetraethoxysilane, tetraisopropoxysilane, and so forth, and alkylalkoxysilanes such as methyltrimethoxysilane, methyltriethoxysilane, methyltriisopropoxysilane, ethyltrimethoxysilane, ethyltriethoxysilane, ethyltriisopropoxysilane, and so forth.

The composition of the present invention may also incorporate the following on an optional basis and in a range in which the objects of the present invention are not impaired: oxidation inhibitors; thickeners; surfactants such as leveling agents, defoamers, sedimentation inhibitors, dispersants, static inhibitors, and antifogging agents; colorants such as pigments, dyes, and so forth; fillers such as aluminum paste, talc, glass frit, metal powder, and so forth; and inhibitors of acrylate autopolymerization, such as butylated hydroxytoluene (BHT), phenothiazine (PTZ), and so forth. Viewed from the perspective of the storage stability of the present composition, an inhibitor of acrylate autopolymerization, e.g., phenothiazine (PTZ), is particularly preferably incorporated at 0.00001 to 0.001 weight part per 100 weight parts component (a).

The method of producing the composition of the present invention may be freely selected, and production can be carried out by mixing the individual components as described above to homogeneity using mechanical force, for example, a mixer. In a preferred embodiment, the composition of the present invention can be obtained by mixing components (a), (b), and (d) and stirring for 0.1 to 10 hours at 25 to 90° C. followed by incorporating the remaining component (c) and other components while stirring.

The photocurable primer composition of the present invention exhibits an excellent affinity for photocuring-type cured coatings comprising an ultraviolet absorber or hindered amine-type photostabilizer and can achieve a tight adhesion between the substrate and photocuring-type cured coating. In addition, this photocurable primer composition exhibits an excellent compatibility among its individual components and thus has a uniform appearance and can therefore form a uniform and highly aesthetically pleasing primer layer on various substrates. Moreover, it offers the advantages of being coatable in a desired thickness by known coating procedures and of not dripping or undergoing component separation post-application.

After the composition of the present invention has been coated and dried on any of various substrates, it can be very rapidly cured by exposure to high energy radiation. This high energy radiation can be exemplified by ultraviolet radiation, electron beam, and γ radiation. The composition of the present invention has a superior ultraviolet curability and thus is most preferably cured using ultraviolet radiation. The use of ultraviolet radiation results in the formation of a cured thin-film layer in a very short period of time. The ultraviolet exposure dose is at least 2 mJ/cm² and preferably is 100 to 3,000 mJ/cm². While the composition of the present invention may be dried at ambient temperature, it can be heated when it is desired to bring about a more rapid drying.

There are no particular limitations on the substrate (L1) on which the composition of the present invention may be coated; however, the substrate is most preferably a substrate that comprises a thermoplastic resin that is readily photodegraded by ultraviolet radiation in the neighborhood of the 300 nm wavelength, e.g., polycarbonate resin. The material constituting the substrate can be exemplified by various plastics, e.g., thermoplastic resins (e.g., polyolefin resins such as polyethylene, polypropylene, and so forth; polyester resins such as polyethylene terephthalate, polyethylene isophthalate, polyethylene-2,6-naphthalate, polybutylene terephthalate, copolymers of the preceding, and so forth; polyamide resins; and also polystyrene, poly(meth)acrylate esters, polyacrylonitrile, polyvinyl acetate, polycarbonate, cellophane, polyimide, polyetherimide, polyphenylene sulfone, polysulfone, polyetherketone, ionomer resins, fluororesins, and so forth) and thermosetting resins (e.g., melamine resins, polyurethane resins, epoxy resins, phenolic resins, unsaturated polyester resins, alkyd resins, urea resins, silicone resins, and so forth); glass; ceramics; metals such as aluminum, zinc, iron, nickel, cobalt, copper, tin, titanium, gold, silver, platinum, and alloys containing the preceding; concrete; wood; fiber-based clothing and fabrics, fibers, and nonwoven fabrics; leather; paper; and stone (including marble).

Thermoplastic resins such as polycarbonate are particularly preferred for the material of the substrate on which the composition of the present invention is coated. This is because the adhesion of the cured coating to the substrate can be improved and the weathering resistance and physical strength of the substrate can be substantially improved when the composition of the present invention is photocured on such a thermoplastic resin substrate to form a primer layer and a photocuring-type cured coating comprising ultraviolet absorber or hindered amine-type photostabilizer is then formed on this primer layer. The shape of the substrate is not particularly limited and can be exemplified by boards, films, sheets, bottles, and solid shapes. Preferred thereamong are thermoplastic plastic boards and thermoplastic plastic films. The thickness of the substrate is not particularly limited and is generally in the range of 5 to 100 μm in the case of film and sheet and in the range of 0.005 m to 0.1 m in the case of thick board.

The method of applying the composition of the present invention is not particularly limited and a thin-film layer of the composition of the present invention can be formed on the surface of various substrates using a known method, for example, flow coating, immersion coating, rotational coating (spin coating), spray coating, curtain coating, gravure coating, Mayer bar coating, dip coating, and so forth.

The quantity of application of the photocurable primer composition may be freely selected, but is preferably a quantity that provides a layer thickness of 0.01 to 25 μm and is more preferably a quantity that provides a layer thickness of 0.05 to 5.0 μm. A quantity that provides a primer layer thickness of 0.1 to 2.0 μM is particularly preferred when the goal is to improve the adhesion to a substrate comprising a thermoplastic resin, e.g., polycarbonate resin and so forth.

A primer layer comprising the photocurable primer composition of the present invention is well suited as a pretreatment for forming a photocuring-type cured coating on a substrate. Thus, a strong adhesion is achieved due to the affinity between the primer layer and the post-photocured cured coating, which results in a substantial improvement in adhesion between the cured coating and substrate that sandwich the primer layer. The primer layer, however, is preferably photocured on the substrate in advance in the present invention. The reason for this is as follows: when—after the photocurable primer composition of the present invention has been applied—the photocuring-type coating agent is applied in the absence of photocuring on the still uncured primer layer, the ultraviolet radiation required for photocuring ends up being absorbed by the cured coating that is the upper layer, and this can cause curing of the primer layer to be inadequate. This is very significant in those instances in which the cured coating is a photocuring-type cured coating that contains an ultraviolet absorber or hindered amine-type photostabilizer.

The primer layer comprising the composition of the present invention is colorless and transparent in the absence of the addition of a colored optional component and is thus very suitable for the surface treatment of transparent substrates that comprise a thermoplastic resin such as polycarbonate resin. Here, a transparent substrate denotes a substrate that has a light transmittance of at least 70% in the visible region and an objectively transparent appearance. More specifically, the transparent substrate can be exemplified by substrates that are plastic members that are substitutes for automotive window glass and/or plastic members that are substitutes for architectural glass.

The structure according to the present invention will now be described. This structure comprises a structure that has the aforementioned (L1) substrate, (L2) a primer layer comprising the hereinabove-described photocurable primer composition, formed on the substrate, and (L3) a cured coating comprising (e) ultraviolet absorber and (c) photopolymerization initiator, formed on the primer layer.

This (L3) component, which is a cured coating adhered to the substrate across the interposed primer layer, is a cured coating that contains (e) ultraviolet absorber and (c) photopolymerization initiator. This cured coating preferably additionally contains (f) a hindered amine-type photostabilizer. This cured coating is a cured coating afforded by the cure of a coating agent that contains components (c) and (e) and preferably is a cured coating afforded by the cure of a coating agent that contains components (c), (e), and (f). This coating agent may be a thermosetting coating agent that undergoes curing with the use of a radical polymerization initiator such as an azobis compound or benzoyl peroxide, but is more preferably a photocuring-type coating agent that is cured by the radicals generated by exposing component (c) to ultraviolet radiation.

This photocuring-type coating agent comprises (A) monomer or oligomer that has a photocurable functional group, the aforementioned component (c), and component (e). The monomer encompassed by component (A) is not particularly limited, but preferred monomer is selected from at least one type of acrylic monomer selected from alkyl methacrylates, alkyl acrylates, multifunctional acrylates, and multifunctional methacrylates and from monomer having a functional group copolymerizable with the preceding. Particularly preferred monomer is the same multifunctional acrylate or multifunctional methacrylate (=component (a)), organoalkoxysilane having an aliphatically unsaturated bond (=component (b)), or mixture thereof as for the primer composition of the present invention. These monomers having a photocurable functional group form a cured coating when photopolymerized by the radicals generated by exposing component (c) to ultraviolet radiation.

The primer layer comprising the photocurable primer composition of the present invention improves the adhesion to substrate of cured coatings that contain both (c) photopolymerization initiator and (e) ultraviolet absorber. This primer layer also improves the adhesion to substrate of cured coatings that additionally contain a (f) hindered amine-type photostabilizer. These components (e) and (f) are components that stop substrate deterioration due to the deleterious effects of ultraviolet radiation, thereby yielding a cured coating that exhibits an excellent ultraviolet-absorbing effect and a high weathering resistance. However, these components can be the cause of an unavoidable inhibition of curing when the photocuring-type coating agent is cured by ultraviolet radiation, and a photocuring-type cured coating that contains these components may therefore exhibit an inadequate adhesion to substrate and debonding of the cured coating may occur.

Component (e) is an ultraviolet absorber, and an ultraviolet absorber having an absorption wavelength at 220 to 400 nm is preferably used for component (e). The presence of this component (e) provides the aforementioned photocuring-type coating agent with an ultraviolet-absorbing effect in the neighborhood of the 300 nm wavelength and thereby improves the weathering resistance of the cured coating.

Viewed from the perspective of balancing a high weathering resistance by the cured coating with the ultraviolet-mediated curability, component (e) is preferably an ultraviolet absorber that has an absorption wavelength at 260 to 400 nm. In specific terms, component (e) is preferably an ultraviolet absorber with a 220-to-400 nm absorption wavelength selected from the group consisting of hydroxyphenyltriazine compounds, benzophenone compounds, and cyanoacrylate compounds; a single one of these may be used or two or more may be used in combination.

Even more specifically, component (e) is at least one ultraviolet absorber selected from hydroxyphenyltriazine compounds such as the 1-methoxy-3-propanol solution of 2-[4-[(2-hydroxy-3-dodecyloxypropyl)oxy]-4,6-bis(2,4-dimethylphenyl)-1,3,5-triazine and 2-[4-[(2-hydroxy-3-tridecyloxypropyl)oxy]-4,6-bis(2,4-dimethylphenyl)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, 2-(2-hydroxy-4-[1-octylcarbonylethoxy]phenyl)-4,6-bis(4-phenylphenyl)-1,3,5-triazine, and so forth; benzophenone compounds such as 2,4-dihydroxybenzophenone, 2-hydroxy-4-n-dodecyloxybenzophenone, 2-hydroxy-4-methoxybenzophenone, and so forth; and cyanoacrylate compounds such as 2-ethylhexyl 2-cyano-3,3′-diphenylacrylate, ethyl 2-cyano-3,3′-diphenylacrylate, and so forth. Hydroxyphenyltriazine compounds are the most preferred.

These ultraviolet absorbers are commercially available and the “TINUVIN 400”, “TINUVIN 405”, and “TINUVIN 479” (TINUVIN is a registered trademark) products provided by Ciba Specialty Chemicals can be suitably used as the hydroxyphenyltriazine compound ultraviolet absorber, wherein the use of “TINUVIN 400” (TINUVIN is a registered trademark) is particular preferred.

Examples of structural formulas of preferred hydroxyphenyltriazine compound as ultraviolet absorbers are provided below.

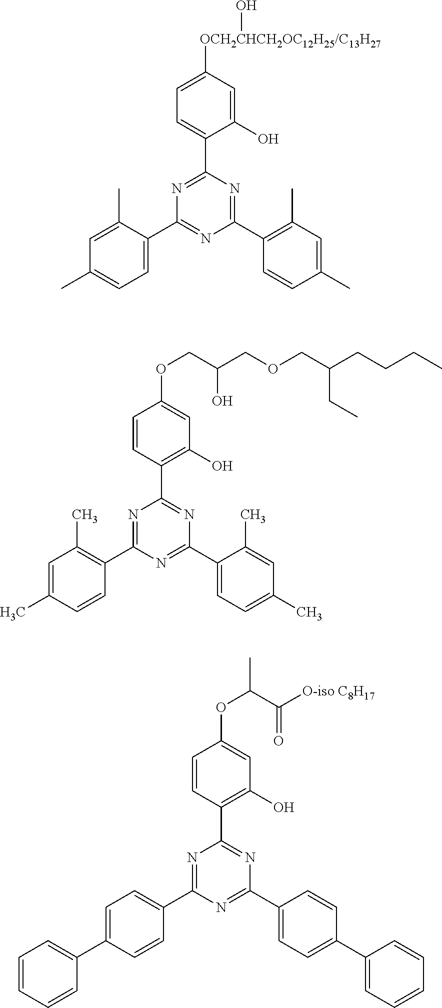

The component (c) content in the (L3) cured coating that comprises (e) ultraviolet absorber and (c) photopolymerization initiator and that is formed on the primer layer in the structure according to the present invention, is preferably 0.01 to 20 weight % of this cured coating and is particularly preferably 1 to 10 weight % when viewed from the perspective of the ultraviolet-absorbing effect of the cured coating, the improvement in the weathering resistance of the cured coating, and the curing characteristics of the composition as a whole. The ultraviolet-stopping effect of the cured coating is unsatisfactory at below the cited lower limit, while exceeding the cited upper limit can result in a reduced strength on the part of the cured coating and a reduced adhesiveness by the cured coating with the primer layer.

The cured coating of the aforementioned (L3) preferably comprises a hindered amine-type photostabilizer as a component (f). This component (f) has the ability to scavenge the radical species generated upon exposure to ultraviolet radiation, and, when it is used in combination with the ultraviolet absorber (e), an excellent synergistic effect is obtained as a consequence with regard to the ultraviolet protective effect of the cured coating and the improvement in the weathering resistance of the cured coating. This hindered amine-type photostabilizer may be a low molecular weight species or a high molecular weight species and mixtures of two or more hindered amine-type photostabilizers may be used in the cured coating constituting the aforementioned (L3); however, a low molecular weight hindered amine-type photostabilizer is preferred.

The low molecular weight hindered amine-type photostabilizer can be exemplified by 2,4-bis[N-butyl-N-(1-cyclohexyloxy-2,2,6,6-tetramethylpiperidin-4-yl)amino]-6-(2-hydroxyethylamine), bis(2,2,6,6-tetramethyl-4-piperidyl) sebacate, bis(1-octyloxy-2,2,6,6-tetramethyl-4-piperidyl) sebacate, bis(1,2,2,6,6-pentamethyl-4-piperidinyl) sebacate, bis(1,2,2,6,6-pentamethyl-4-piperidyl) 2-(3,5-di-tert-butyl-4-hydroxybenzyl)-2-n-butylmalonate, tetrakis(1,2,2,6,6-pentamethyl-4-piperidyl) 1,2,3,4-butanetetracarboxylate, 1,2,2,6,6-pentamethyl-4-piperidyl/tridecyl 1,2,3,4-butanetetracarboxylate, and {1,2,2,6,6-pentamethyl-4-piperidyl/β,β,β′,β′-tetramethyl-3,9-[2,4,8,10-tetraoxaspiro(5,5)undecane]diethyl} 1,2,3,4-butanetetracarboxylate.

The high molecular weight hindered amine-type photostabilizer can be exemplified by dimethyl succinate/1-(2-hydroxyethyl)-4-hydroxy-2,2,6,6-tetramethylpiperidine polycondensate, N,N′-bis(3-aminopropyl)ethylenediamine/2,4-bis[N-butyl-N-(1,2,2,6,6-pentamethyl-4-piperidyl)amino]-6-chloro-1,3,5-triazine condensate, poly[[6-[(1,1,3,3-tetramethylbutyl)amino]-1,3,5-triazin-2,4-diyl][(2,2,6,6-tetramethyl-4-piperidinyl)imino]], poly[{6-(1,1,3-trimethylpentyl)amino-1,3,5-triazin-2,4-diyl} {(N-methyl-2,2,6,6-tetramethylpiperidyl)imino}octamethylene {(N-methyl-2,2,6,6-tetramethylpiperidyl)imino}], poly[(6-mopholino-s-triazin-2,4-diyl)[1,2,2,6,6-pentamethyl-4-piperidyl]imino]hexamethylene[(1,2,2,6,6-pentamethyl-4-piperidyl)imino]], and poly[{6-(1,1,3,3-tetramethylbutyl)amino-1,3,5-triazin-2,4-diyl} {(2,2,6,6-tetramethylpiperidyl)imino}hexamethylene {(2,2,6,6-tetramethylpiperidyl)imino}].

These photostabilizers are commercially available and can be exemplified by the “TINUVIN 111 FDL”, “TINUVIN 123”, “TINUVIN 144”, “TINUVIN 152”, “TINUVIN 292”, and “TINUVIN 5100” (TINUVIN is a registered trademark) products provided by Ciba Specialty Chemicals, and the structures of these photostabilizers are shown by the following formulas.

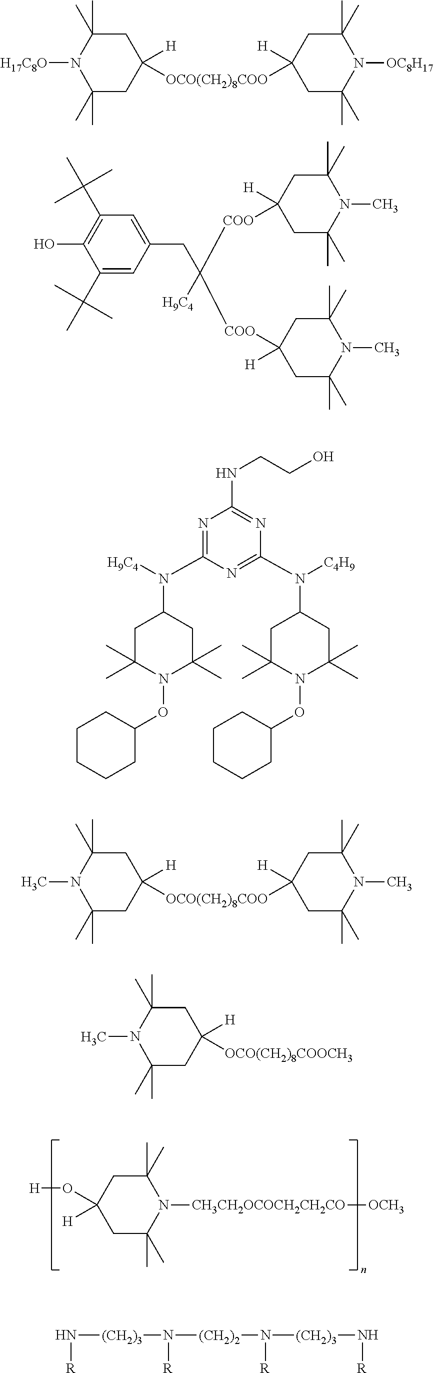

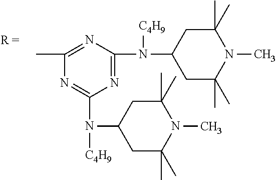

The amount of component (f) incorporation in the (L3) cured coating of the structure according to the present invention is preferably 0.1 to 15 weight % of this cured coating. The ultraviolet protective effect exercised by the cured coating and the improvement in the cured coating's weathering resistance that are achieved as synergistic effects with component (e) may be inadequate at below the cited lower limit, while an overly large amount of component (f) incorporation can reduce the strength of the cured coating and can reduce the ultraviolet curability.

Colloidal silica is preferably incorporated in the (L3) cured coating of the structure according to the present invention as a component that will increase the hardness of the cured coating and thereby improve the resistance to scratching and marring. The silica surface of this colloidal silica may be modified by a hydrolyzable silicon group or the silanol group insofar as the objects of the present invention are not impaired.

This colloidal silica can be incorporated into the photocuring-type coating agent that forms the (L3) cured coating in the form of a colloidal silica dispersion that is a single mass with a dispersion medium such as, for example, water, an alcohol, and particularly propylene glycol monomethyl ether (PGM). The average particle size of the colloidal silica is suitably no greater than 200 nm from the standpoint of its dispersibility and preferably is 1 to 100 nm and particularly preferably is 1 to 50 nm. When a colloidal silica dispersion is used, the colloidal silica content, i.e., the colloidal silica concentration, may be freely selected, but is preferably 10 to 70 weight % from the standpoint of the ease of handling.

The (L3) cured coating of the structure regarding the present invention preferably incorporates an amino-modified organopolysiloxane as a component that imparts water repellency and lubricity. This amino-modified organopolysiloxane can be exemplified by organopolysiloxane fluid that has an amino-functional organic group at the molecular chain terminals or in a portion of the side chains.

The amino-functional organic group can be exemplified by 2-aminoethyl, 3-aminopropyl, 3-(2-aminoethyl)aminopropyl, and 6-aminohexyl. The silicon-bonded groups other than the amino-functional organic group can be exemplified by alkyl such as methyl, ethyl, propyl, and so forth; aryl such as phenyl and so forth; alkoxy such as methoxy, ethoxy, propoxy, and so forth; and the hydroxyl group. Methyl is preferred among the preceding. The molecular structure of the organopolysiloxane is preferably straight chain or a straight chain that is partially branched. Its siloxane degree of polymerization is preferably in the range of 2 to 1000, more preferably 2 to 500, and particularly preferably 2 to 300.

The component (c) used in the photocuring-type coating agent that provides the (L3) cured coating in the structure regarding the present invention can be exemplified by the same components as for the component (c) that is incorporated in the previously described photocurable primer composition of the present invention. However, in the case of application as a surface treatment for polycarbonate resin products, which are readily photodegraded and deteriorated by ultraviolet radiation around a wavelength of 300 nm, a (c1) photopolymerization initiator having an absorption wavelength at 300 to 450 nm is preferably used as the component (c) in the photocuring-type coating agent. This offers the following advantage: by promoting the cure of the photocurable primer composition of the present invention by exposure to ultraviolet radiation in the wavelength region of 300 to 450 nm, which are wavelengths that have little effect on, for example, polycarbonate resin, the photodegradation/deterioration of a substrate comprising a thermosetting resin such as polycarbonate resin that accompanies the ultraviolet cure of the primer layer can be inhibited. A photopolymerization initiator that has an absorption wavelength at 360 to 450 nm is particularly preferred from the standpoint of inhibiting substrate photodegradation/deterioration. The organic solvent (d) and other optional components used in the photocuring-type coating agent can also be exemplified by the same components as the components incorporated in the previously described photocurable primer composition of the present invention. The method of coating the primer layer with the photocuring-type coating agent that provides the (L3) cured coating and the method of photocuring this photocuring-type coating agent by exposure to ultraviolet radiation can be exemplified by the same methods as for the previously described photocurable primer composition of the present invention.

In those instances where resistance to scratching and marring is required, the quantity of the (L3) cured coating of the structure regarding the present invention preferably provides a layer thickness of 0.5 to 25 μm and more preferably a layer thickness of 1 to 20 μM.

A photocuring-type coating agent comprising (A) 100 weight parts of monomer or oligomer that has a photopolymerizable functional group, (c1) 0.01 to 30 weight parts of photopolymerization initiator that has an absorption wavelength at 300 to 450 nm, (e) 0.01 to 20 weight parts of ultraviolet absorber, (f) 0.1 to 15 weight parts of hindered amine-type photostabilizer, 1 to 300 weight parts of colloidal silica, 0.2 to 20 weight parts of amino-modified organopolysiloxane, and (d) 10 to 1,000 weight parts of organic solvent is a particularly suitable coating agent for providing the (L3) cured coating in the structure according to the present invention.

The structure according to the present invention can be obtained by a production method that characteristically comprises a step of coating the photocurable primer composition of the present invention on a substrate; a step of photocuring the photocurable primer composition to form a primer layer; a step of coating the primer layer with the previously described photocuring-type coating agent; and a step of photocuring the photocuring-type coating agent to form a cured coating that comprises (c) photopolymerization initiator and (e) ultraviolet absorber.

The structure according to the present invention has a structure in which a weathering-resistant cured coating—a cured coating that also exhibits an excellent ultraviolet-absorbing effect at wavelengths around 300 nm as well as an excellent hardness, excellent antifouling property to the adhesion of oily and fatty contaminants, excellent behavior with regard to wiping off oily or fatty contaminants, excellent resistance to scratching and marring, excellent transparency, excellent water repellency, excellent adhesiveness, excellent smoothness, and excellent uniformity—is tightly adhered to a substrate as described above. As a consequence, this structure is very well suited in particular for members that are substrates used in environments in which long-term exposure to sunlight occurs (e.g., outdoors) and that must present strength and pleasing appearance and more specifically is very well suited for plastic members that are substitutes for automotive window glass and plastic members that are substitutes for architectural glass.

### EXAMPLES

The present invention is specifically described in the following using examples and comparative examples; however, the present invention is not limited to the following examples. In the examples that follow, parts denotes weight parts in all instances, while the viscosity is the value measured at 25° C., and Me indicates the methyl group. The properties referenced in the examples and comparative examples were measured using the methods described below. The structures of the compounds were determined using ¹H, ¹³C-NMR.

[Viscosity of the Photocuring-Type Coating Agent]

The viscosity was measured at 25° C. using an E-type viscometer (DIGITAL VISCOMETER from TOKIOMEC).

### [Hot Water Immersion Testing: Evaluation of the Adhesion Between the Cured Coating and Substrate]

The sample, which had the cured coating on the surface of a substrate, was immersed in hot water held at 100° C., and the presence/absence of separation of pieces of the cured coating was evaluated after 0.5, 1.0 and 2.0 hours; this evaluation was based on whether separated pieces of the cured coating were seen floating to the surface.

### Production Example 1

14. 2 g of methyl ethyl ketone (MEK), 17.4 g of ester-type multifunctional urethane acrylate (product name: KAYARAD UX-5000, from Nippon Kayaku Co., Ltd.), and 0.36 g of 3-aminopropyl-diterminated polydimethylsiloxane (BY 16-853U from Dow Corning Toray Co., Ltd.) were introduced into a flask and were stirred for 1 hour while heating at 50° C. Once cooled, 5.78 g of 3-methacryloxytrimethoxysilane, 57.8 g of PGM dispersion of colloidal silica (concentration=30 wt %, average particle size of the colloidal silica=13 nm), and 0.58 g of water were added in the sequence given with stirring, after which heating was carried out to 50° C. and stirring was performed for 1 hour. After cooling, a “photocuring-type coating agent” was prepared by adding the following: 2.10 g of 2-methyl-1-[4-(methylthio)phenyl]-2-morpholinopropan-1-one (Irgacure 907 from Ciba Specialty Chemicals) as photopolymerization initiator, 1.0 g of 1-methoxy-3-propanol solution of 2-[4-[(2-hydroxy-3-dodecyloxypropyl)oxy]-4,6-bis(2,4-dimethylphenyl)-1,3,5-triazine and 2-[4-[(2-hydroxy-3-tridecyloxypropyl)oxy]-4,6-bis(2,4-dimethylphenyl)-1,3,5-triazine (TINUVIN 400 from Ciba Specialty Chemicals) as ultraviolet absorber, 0.8 g of 2,4-bis[N-butyl-N-(1-cyclohexyloxy-2,2,6,6-tetramethylpiperidin-4-yl)amino]-6-(2-hydroxyethylamine) (TINUVIN 152 from Ciba Specialty Chemicals) as photostabilizer, and 4.3 mg of phenothiazine. This photocurable-type coating agent had a viscosity of 6 mPa·s.

### Primer Production Examples

### Examples 1 to 3 and Comparative Example 1

The components shown in Table 2 below were mixed to homogeneity using mechanical force to prepare primer-1 to primer-4. Primers-1 to -3 are photocurable primer compositions that are examples of the invention of the present application, while primer-4, which is a comparative example, is a thermosetting primer coating agent that contains a radical polymerization initiator. The amount of incorporation for each component is given in mass parts in the table.

TABLE 1

| | | | | Comp. |
|---|---|---|---|---|
| | Example 1 | Example 2 | Example 3 | Ex. 1 |
| component/(mass parts) | primer-1 | primer-2 | primer-3 | primer-4 |
| methyl methacrylate | | | | 5.64 |
| multifunctional acrylate | 5.64 | | | |
| DPHA (*1) | | | | |
| multifunctional acrylate | | 5.64 | | |
| UX-5000 (*2) | | | | |
| multifunctional acrylate | | | 5.64 | |
| DPHA-40H (*3) | | | | |
| 3-methacryloxy- | 2.42 | 2.42 | 2.42 | 2.42 |
| trimethoxysilane | | | | |
| <radical poly- | | | | 0.10 |
| merization initiator> | | | | |
| 2,2′-azobis(2- | | | | |
| methylbutyronitrile) | | | | |
| <photopolymerization | 0.10 | 0.10 | 0.10 | |
| initiator> | | | | |
| Irgacure 907 (*4) | | | | |
| xylene | | | | 9.97 |
| toluene | 9.97 | 9.97 | 9.97 | |
| cyclohexanone | | | | 1.88 |
| methyl isobutyl ketone | 1.88 | 1.88 | 1.88 | |
| polyethylene glycol | 80.00 | 80.00 | 80.00 | 80.00 |
| monomethyl ether | | | | |

(*1) DPHA: dipentaerythritol hexaacrylate/dipentaerythritol pentaacrylate (multifunctional acrylate, product name: KAYARAD DPHA, from Nippon Kayaku Co., Ltd.)
(*2) UX-5000 (ester-type multifunctional urethane acrylate, product name: KAYARAD UX-5000, from Nippon Kayaku Co., Ltd.)
(*3) DPHA-40H (ester-type multifunctional urethane acrylate, product name: KAYARAD DPHA-40H, from Nippon Kayaku Co., Ltd.)
(*4) Irgacure 907: 2-methyl-1-[4-(methylthio)phenyl]-2-morpholinopropan-1-one (product name: Irgacure 907, from Ciba Specialty Chemicals)

### Examples 1 to 3

Each of primers-1 to -3 was uniformly coated using a spin coater on a 3 mm-thick polycarbonate plate and dried for 5 minutes at 120° C. in an oven. Photocuring was then carried out by exposure to 2,000 mJ/cm² ultraviolet radiation using a UVC-02512S1AA01 from USHIO Electric, Inc. (lamp: UVH-0251C-2200 metal halide lamp) to form a uniform primer layer (primer layer thickness approximately 0.7 μm) comprising primer-1 to -3 on the respective polycarbonate plate surfaces.

The previously described photocuring-type coating agent was then coated on the primer layer on the 3 mm-thick polycarbonate plate using a No. 9 Mayer bar followed by drying for 2 minutes at 120° C. Curing was subsequently carried out by exposure to 2,000 mJ/cm² ultraviolet radiation using a UVC-02512S1AA01 from USHIO Electric, Inc. (lamp: UVH-0251C-2200 metal halide lamp) to obtain a polycarbonate plate having the primer layer between the substrate and an 8 μm-thick cured coating (thin film layer). Table 3 reports the results of hot water immersion testing on these substrates.

### Comparative Example 1

Primer-4 was uniformly coated using a spin coater on a 3 mm-thick polycarbonate plate and the heat-induced radical polymerization of primer-4 was then performed by standing for 2 hours at 120° C. in an oven to form a uniform primer layer (primer layer thickness approximately 0.7 μm) comprising primer-4 on the surface of the polycarbonate plate.

The previously described photocuring-type coating agent was then coated on the primer layer on the 3 mm-thick polycarbonate plate using a No. 9 Mayer bar followed by drying for 2 minutes at 120° C. Curing was subsequently carried out by exposure to 2,000 mJ/cm² ultraviolet radiation using a UVC-0251251AA01 from USHIO Electric, Inc. (lamp: UVH-0251C-2200 metal halide lamp) to obtain a polycarbonate plate having the primer layer between the substrate and an 8 μm-thick cured coating (thin film layer). Table 3 reports the results of hot water immersion testing on this substrate.

### Comparative Example 2

A polycarbonate plate bearing only an 8 μm-thick cured coating (thin film layer) from the previously described photocuring-type coating agent of the present invention was obtained by proceeding as in Examples 1 to 3, but omitting the use of the primer. Table 3 reports the results of hot water immersion testing on this substrate.

TABLE 2

| | | | | Compara- | Compara- |
|---|---|---|---|---|---|
| | | | | tive | tive |
| | Example 1 | Example 2 | Example 3 | Example 1 | Example 2 |
| primer | primer-1 | primer-2 | primer-3 | primer-4 | none |
| type of | photocurable | | | thermo- | — |
| primer | | | | setting | |
| <hot water | | | | | |
| immersion | | | | | |
| testing> | | | | | |
| 0.5 hour | no | no | no | no | separation |
| | separation | separation | separation | separation | |
| 1.0 hour | no | no | no | no | — |
| | separation | separation | separation | separation | |
| 2.0 hours | no | no | no | partial | — |
| | separation | separation | separation | separation | |

As is shown in Table 3, separation of the cured coating was not occurred even by hot water immersion for 2 hours in the case of the primer layer-bearing polycarbonate plates of Examples 1 to 3 and an excellent adhesion was thus maintained. In contrast to this, separation of the cured coating was occurred after the 2-hour hot water immersion in Comparative Example 1, which employed a thermosetting primer layer, and thus the adhesion of the cured coating was inferior to that of the primer layer-bearing polycarbonate plates of Examples 1 to 3. In the case of the polycarbonate plate of Comparative Example 2 (absence of primer layer), the cured coating was separated by a brief hot water immersion.

### INDUSTRIAL APPLICABILITY

As described in the preceding, the photocurable primer composition of the present invention is useful as a primer for use as an undercoating for coating agents and film-forming agents for various substrates. In particular, the photocurable primer composition of the present invention, through its use in combination with a cured coating provided by curing a photocuring-type coating agent that comprises an ultraviolet absorber and/or photostabilizer, is particularly well suited for improving the surface protection and weathering resistance of polycarbonate resin products, which are readily susceptible to photodegradation and deterioration by ultraviolet radiation around the 300 nm wavelength. The photocurable primer composition is thus extremely useful as a primer for use as an undercoating for surface coating agents for automotive external trim and external building features, which are used in environments in which long-term exposure to sunlight occurs, e.g., outdoors and so forth.

In addition, the photocurable primer composition of the present invention can also be applied—in its role as a primer for use as an undercoating for weathering-resistant cured coatings that exhibit an ultraviolet-absorbing effect—to highly flexible low-hardness substrates such as natural rubber and synthetic rubber, thereby enabling the formation of cured coatings on these flexible substrates. The synthetic rubber can be exemplified by SBR, NBR, EPM, EPDM, nitrile rubber, urethane rubber, norbornene rubber, acrylic rubber, chloroprene rubber, epichlorohydrin rubber, silicone rubber, fluororubber, and so forth. In the particular case of flexible silicone rubber substrates, it is useful to form an ultraviolet-absorptive surface protective layer on, for example, a keypad or roll surface, after the formation of a primer layer comprising the primer composition of the present invention. These substrates may have any configuration, e.g., sheet, film, roll, tube, various moldings, and so forth. In addition, substrate loaded with any of various fillers can be used without restriction. Among the preceding, the preliminary formation of a primer layer by coating the inventive primer composition on a belt- or roll-shaped substrate or on any of various keypad substrates makes possible the facile formation of a cured coating that provides the substrate surface with functionalities such as weathering resistance, ultraviolet absorptivity, resistance to the adhesion of oily and fatty contaminants, ability to enable the wiping off of oily and fatty contaminants, resistance to scratching and marring, abrasion resistance, and so forth—and does so without impairing the durability or shape-following ability with the substrate. These flexible substrates having a cured coating on the primer layer are useful, for example, as key tops for keypads for, inter alia, portable phones and various remote controls, and as components of office automation equipment such as copiers and printers, e.g., charging rolls, transfer rolls, transfer belts, intermediate transfer belts, developing rolls, fixing rolls, cleaning blades, and so forth.

1. A photocurable primer composition comprising
(a) a multifunctional acrylate or multifunctional methacrylate,
(b) an organoalkoxysilane having an aliphatically unsaturated bond,
(c) a photopolymerization initiator, and
(d) an organic solvent.

2. A structure comprising
(L1) a substrate,
(L2) a primer layer comprising the photocurable primer composition of claim 1, formed on the substrate, and
(L3) a cured coating comprising (e) ultraviolet absorber and (c) photopolymerization initiator, formed on the primer layer.

3. The structure according to claim 2, characterized in that the cured coating further comprises
(f) hindered amine-type photostabilizer.

4. The structure according to claim 2, characterized in that the substrate is a transparent substrate that has a light transmittance of at least 70% in the visible region, and wherein the structure is substantially transparent.

5. A method of producing the structure described in claim 2, said method comprising:
a step of coating the photocurable primer composition of claim 1 on a substrate;
a step of photocuring the photocurable primer composition to form a primer layer;
a step of coating, on the aforementioned primer layer, a photocuring-type coating agent comprising (e) ultraviolet absorber and (c) photopolymerization initiator; and
a step of photocuring the photocuring-type coating agent to form a cured coating comprising the (e) ultraviolet absorber and (c) photopolymerization initiator.

6. The method of producing according to claim 5, characterized in that the substrate is polycarbonate resin and the cured coating is a cured coating comprising (c) photopolymerization initiator, (e) ultraviolet absorber, and (f) hindered amine-type photostabilizer.

7. The structure according to claim 2, characterized in that the substrate is polycarbonate resin.

8. The structure according to claim 2, characterized in that the multifunctional acrylate or multifunctional methacrylate is at least difunctional and is free of fluorine and/or silicon atoms.

9. The structure according to claim 2, characterized in that the organoalkoxysilane is of the general formula R¹ₐYSi(OR²)₃₋ₐ, wherein
R¹ is substituted or unsubstituted monovalent hydrocarbyl that does not contain an aliphatically unsaturated bond,
R² is alkyl,
Y is a monovalent organic group that contains an aliphatically unsaturated bond, and
a is 0 or 1.

10. The structure according to claim 9, wherein
R¹ is methyl, ethyl, propyl, butyl, isobutyl, phenyl, or fluoroalkyl,
R² is methyl, ethyl, or propyl, and
Y is an acrylic group-containing organic group, an alkenyl group, a styryl group, or a vinyl ether group.
